(19) United States
(12) Patent Application Publication
(10) Pub. No.: US 2020/0327827 A1
(43) Pub. Date: Oct. 15, 2020

(54) Advertising Piece with Transparent Label for Covering Card Attached to Mailer

(71) Applicant: WILopEN Products, LC, Deerfield Beach, FL (US)

(72) Inventors: Paul G. Caravello, Lake Grove, NY (US); Corey Wilen, Plainview, NY (US); Gordon M. Kramer, Coral Springs, FL (US)

(73) Assignee: WILopEN Products, LC, Deerfield Beach, FL (US)

(21) Appl. No.: 16/846,515

(22) Filed: Apr. 13, 2020

Related U.S. Application Data
(60) Provisional application No. 62/832,630, filed on Apr. 11, 2019.

(51) Int. Cl. G09F 1/04; B65D 25/20

(52) U.S. Cl. CPC G09F 1/04; B65D 25/205

(57) ABSTRACT

An advertising piece for inducing a customer to view an advertisement is described. The advertising piece includes an advertising article, a detachable card that is removably attached to a surface of the advertising article, and a transparent label that covers a front face of the detachable card and connects to the advertising article. The detachable card is attached to the surface of the advertising article within a pocket formed between a rear side of the transparent label and the surface of the advertising article. Adhesive may also be used to secure the detachable card to the advertising article.

### CROSS REFERENCE TO RELATED APPLICATIONS

This application is a nonprovisional application of and claims priority from U.S. provisional patent application Ser. No. 62/832,630, filed on Apr. 11, 2019. The foregoing application is incorporated in its herein by reference.

### FIELD OF THE INVENTION

The invention relates to advertising. More particularly, the invention relates to a flyer having an attached card that is covered by a detachable transparent label.

### BACKGROUND

Mailers and flyers, generally made from paper, are frequently used for purposes of advertising and promotion. Such articles can include advertising and product information and information concerning the retailer or manufacturer. Consumers who receive such advertisements are accustomed to being targeted with advertising and often disregard or discard advertisements without viewing them, thereby reducing or eliminating the effectiveness of the advertising.

A need exists for advertising mailers and flyers that induce consumers to view, read, or examine their advertising content more closely so that the advertising message reaches more consumers with the goal of increasing its effectiveness in increasing sales.

### SUMMARY

The invention relates to an advertising piece for inducing a customer to view an advertisement and promotion. The advertising piece includes an advertising article, a detachable card that is removably attached to a surface (e.g., a first side) of the advertising article, and a transparent label that covers a front face of the detachable card and connects to the advertising article. The detachable card is attached to the surface of the advertising article within a pocket formed between a rear side of the transparent label and the surface of the advertising article. The detachable card can be sized and shaped similar or identical to the size and shape of a debit card or credit card. Adhesive may also be used to secure the detachable card to the advertising article.

The advertising piece provides an advantage over other traditional types of advertisements by using the size and shape of the detachable card, which is made to be similar to a debit card or credit card, to pique the curiosity of recipient to induce that person to view, read, or examine the advertising content more closely. The advertising methods associated with use of the advertising piece ensure that the advertising message reaches more consumers with the goal of increasing its effectiveness in increasing sales. The advertising piece provides another advantage by encouraging a recipient to view the advertisement by concealing a code for a discount or prize or other printed matter on a rear face of the detachable card, which is only accessible by removal of the transparent label and detachment of the detachable card from the advertising article.

Accordingly, the invention features an advertising piece that includes an advertising article having a first side and at least a second side, a detachable card that is removably attached to the first side of the advertising article, and a transparent label that covers a front face of the detachable card and connects to the advertising article.

In another aspect, the invention can feature the detachable card being attached to the first side of the advertising article within a pocket formed between a rear side of the transparent label and the first side of the advertising article.

In another aspect, the invention can feature the advertising article, the detachable card, or both including printed matter.

In another aspect, the invention can feature a rear face of the detachable card including concealed printed matter that is viewable when the detachable card is detached from the advertising article.

In another aspect, the invention can feature the concealed printed matter printed on the rear face of the detachable card including or being a code for obtaining a discount off a purchase price of goods or services or for obtaining a prize that is or includes free goods or services or money.

In another aspect, the invention can feature the advertising article being or including a mailer or a flyer.

In another aspect, the invention can feature the advertising article being or including a magazine, a newspaper, a brochure, a letter envelope, a folder, a package envelope, or a box.

In another aspect, the invention can feature the detachable card being a length of about 85.60 mm and a height of about 53.98 mm.

In another aspect, the invention can feature the detachable card being generally rectangular in shape and having rounded corners, wherein each rounded corner has a radius of about 2.88 mm to about 3.48 mm.

In another aspect, the invention can feature the detachable card being shaped and sized generally the same as a debit card or credit card.

In another aspect, the invention can feature the transparent label including or being a plastic film or a laminate that is attachable over the detachable card and onto the first side of the advertising article.

In another aspect, the invention can feature the transparent label being clear or colored.

In another aspect, the invention can feature the transparent label being sized to cover the detachable card with sufficient additional material to overlap outer edges of the detachable card so as to allow attachment of the transparent label to the advertising article around the outer edges of the detachable card.

In another aspect, the invention can feature the detachable card being or including a piece of material folded into a bifold or trifold configuration that is openable after detachment of the detachable card from the advertising article.

In another aspect, the invention can feature the advertising piece further including adhesive that is used to attach the detachable card to the first side of the advertising article. The adhesive can be present on the rear face of the transparent label, on the first side of the advertising article but not on the transparent label, or on both the rear face of the transparent label and the first side of the advertising article.

The invention also features an advertising system that includes an advertising article having a first side and at least a second side, a detachable card that is removably attached to the first side of the advertising article, a transparent label that covers a front face of the detachable card and connects to the advertising article, and a code printed on the detachable card. The code is concealed when the detachable card is attached to the advertising article and is viewable upon detachment of the detachable card from the advertising article.

In another aspect, the invention can feature the code being printed on a rear face of the detachable card or inside the detachable card.

The invention also features a method for advertising that induces a consumer to view, read, or examine an advertisement, the method including the steps of: (a) providing an advertising piece that includes an advertising article having a first side and at least a second side, a detachable card that is removably attached to the first side of the advertising article, and a transparent label that covers a front face of the detachable card and connects to the advertising article; (b) delivering the advertising piece to a consumer; (c) removing the transparent label from the advertising article to uncover the detachable card; and (d) detaching the detachable card from the advertising article to view concealed printed matter printed on the detachable card.

In another step of the method, the concealed printed matter is printed on a rear face of the detachable card or inside the detachable card.

In another step of the method, the detachable card includes a piece of material folded into a bifold or trifold configuration. The method further includes the step of: (e) unfolding the detachable card after its detachment from the advertising article for viewing of the concealed printed matter.

Unless otherwise defined, all technical terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents and other references mentioned herein are incorporated by reference in their entirety. In the case of conflict, the present specification, including definitions will control.

### BRIEF DESCRIPTION OF THE DRAWINGS

FIG. 1 is a plan view of one side of an advertising piece as described herein.

### DETAILED DESCRIPTION

The present invention is best understood by reference to the detailed drawings and description set forth herein. Embodiments of the invention are discussed below with reference to the drawings; however, those skilled in the art will readily appreciate that the detailed description given herein with respect to these figures is for explanatory purposes as the invention extends beyond these limited embodiments. For example, in light of the teachings of the present invention, those skilled in the art will recognize a multiplicity of alternate and suitable approaches, depending upon the needs of the particular application, to implement the functionality of any given detail described herein beyond the particular implementation choices in the following embodiments described and shown. That is, numerous modifications and variations of the invention may exist that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention should not be limited to the particular methodology, compounds, materials, manufacturing techniques, uses, and applications, described herein, as these may vary. The terminology used herein is used for the purpose of describing particular embodiments only, and is not intended to limit the scope of the present invention. As used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” may be a reference to one or more steps or means and may include sub-steps and subservient means.

All conjunctions used herein are to be understood in the most inclusive sense possible. Thus, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. Structures described herein are to be understood also to refer to functional equivalents of such structures. Language that may be construed to express approximation should be so understood unless the context clearly dictates otherwise.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “having” should be interpreted as “having at least”; the term “includes” should be interpreted as “includes but is not limited to”; the term “example” is used to provide exemplary instances of the item in discussion, not an exhaustive or limiting list thereof; and use of terms like “preferably,” “preferred,” “desired,” “desirable,” or “exemplary” and words of similar meaning should not be understood as implying that certain features are critical, essential, or even important to the structure or function of the invention, but instead as merely intended to highlight alternative or additional features that may or may not be utilized in a particular embodiment of the invention.

Those skilled in the art will also understand that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations; however, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

All numbers expressing dimensions, quantities of ingredients, reaction conditions, and so forth used in the specification are to be understood as being modified in all instances by the term “about” unless expressly stated otherwise. Accordingly, unless indicated to the contrary, the numerical parameters set forth herein are approximations that may vary depending upon the desired properties sought to be obtained.

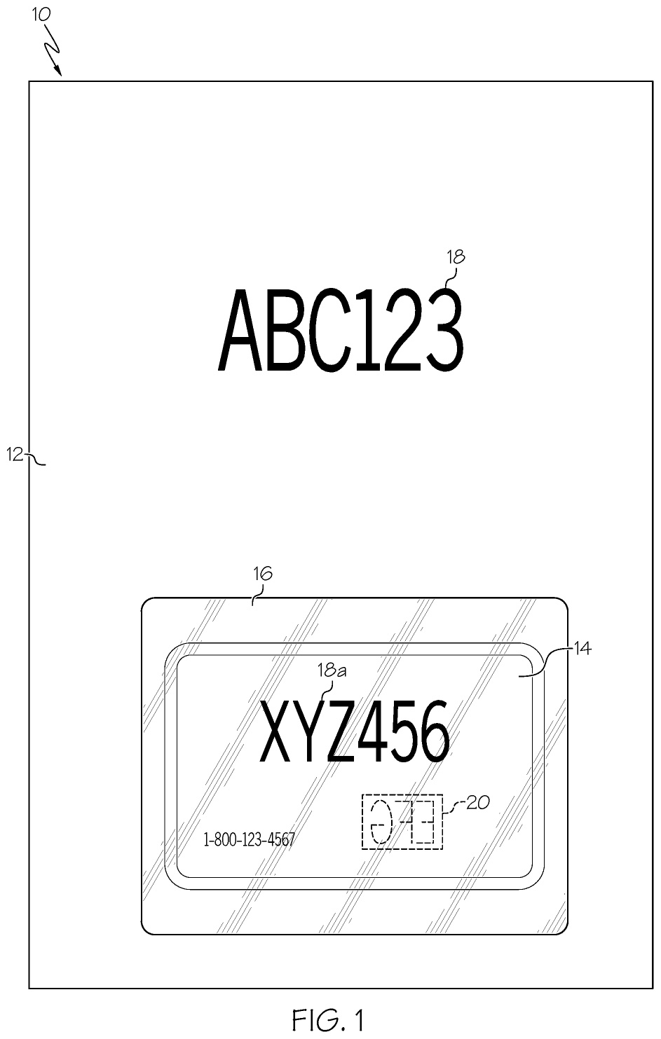

The invention provides systems and methods for advertising that include an advertising piece 10. As shown in FIG. 1, the advertising piece 10 includes an advertising article 12 (for example, a mailer or flyer) that includes a detachable card 14 attached to the advertising article beneath a transparent label 16. The advertising article 12, as mentioned above, can be a mailer or flyer that is mailed or otherwise distributed to recipients who are customers or potential customers for the goods or services described in advertising content 18 that is printed on the advertising article, the detachable card 14, or both. In other embodiments, the advertising article 12 can be a magazine, a newspaper, a brochure, a letter envelope, a folder, a package envelope, or a box to which the detachable card 14 is attached and covered with the transparent label 16. The advertising article 12 can be made of paper, cardboard, plastic, metal (e.g., foil), a combination of two or more of the foregoing, or any other suitable material. The advertising article 12 includes a front face and a rear face. Advertising content 18 may be printed on one or both faces of the advertising article 12. In exemplary embodiments, the advertising article 12 may be rectangular in shape having four sides, although in other embodiments, the advertising article may be circular, triangular, polygonal, irregular, or any other shape. The advertising article 12 can be constructed from a single ply of material or from two, three, four, five, or more connected plies of material (e.g., “sandwiched” or laminated construction of a single-sheet advertising article from multiple layers of stacked, connected plies of material).

The detachable card 14 can be removably attached to the advertising article 12 by an adhesive in some embodiments, although in exemplary embodiments, the detachable card is removably attached to the advertising article by the transparent label 16. The detachable card 14 can be made of paper, cardboard, plastic, metal (e.g., foil), a combination of two or more of the foregoing, or any other suitable material. In some embodiments of the invention, the detachable card 14 may be made from a material or materials that differ from the material or materials used in the construction of the advertising article 12. The detachable card 14 includes a front face and a rear face. Advertising content 18 may be printed on one or both faces of the detachable card 14. In exemplary embodiments, the detachable card 14 may be rectangular in shape having four sides, although in other embodiments, the detachable card may be circular, triangular, polygonal, irregular, or any other shape. The detachable card 14 can be constructed from a single ply of material or from two, three, four, five, or more connected plies of material (e.g., “sandwiched” or laminated construction of a single-sheet detachable card from multiple layers of stacked, connected plies of material). In some embodiments of the invention, the detachable card 14 may include a number of plies of material that differ from the number of plies of material included in the advertising article 12.

The detachable card 14 can be made in any shape or size. For example, the detachable card can be rectangular, circular, triangular, polygonal, irregular, or any other shape. However, in exemplary embodiments, the detachable card 14 is shaped and sized to conform to the ISO/IEC 7810 ID-1 standard (about 85.60 mm long by about 53.98 mm high (about 3⅜ inches long by about 2⅛ inches high). The standard size used for the detachable card 14 in exemplary embodiments, which is the same as the size used for payment cards, is also called CR-80. In exemplary embodiments such as those that meet the foregoing ISO/IEC 7810 ID-1 standard or CR-80 standards, the detachable card 14 has rounded corners, for example, with a radius of about 2.88 mm to about 3.48 mm. In other embodiments, the detachable card 14 may have angular corners. The foregoing dimensions, including rounded corner dimensions, are the same as those used for debit and credit cards as well as many gift cards and other payment cards. Consumers have a natural affinity for cards of that shape and size due to the association with payment cards, and thus, producing the detachable card 14 in the same or a similar shape and size encourages recipients to remove the transparent label 16 to view the code or other printed matter 20 on the rear face of the detachable card 14.

In some embodiments, the detachable card 14 is constructed from a piece of material that is folded into a bifold (i.e., having two halves or sections) or trifold (i.e., having three sections) configuration that is openable after detachment of the detachable card from the advertising article 12. In other embodiments, the piece of material forming the detachable card 14 may be folded into four, five, or more sections. The detachable card 14 can include concealed printed matter 20 that is viewable when the detachable card is detached from the advertising article 12. The concealed printed matter 20 can be printed on the rear face of the detachable card 14 or inside the detachable card in embodiments that have a folded configuration. In exemplary embodiments, the concealed printed matter 20 can be a code for obtaining a discount off a purchase price of goods or services or for obtaining a prize that is or includes free goods or services or money.

The transparent label 16 is a plastic film or laminate in exemplary embodiments. The transparent label 16 may be clear or colored. The transparent label 16 includes a front face and a rear face. The rear face of the transparent label 16 is attached over the detachable card 14 and to the surface of the advertising article 12. In one embodiment, the rear face of the transparent label 16 includes an adhesive that is used to attach it to the surface of the advertising article 12. In another embodiment, the adhesive is present on the surface of the advertising article 12 but not on the transparent label 16. In still another embodiment, both the rear face of the transparent label 16 and the surface of the advertising article 12 include adhesive so that the transparent label may be attached to the advertising article over the detachable card 14. The transparent label 16 is sized to cover the detachable card 14 with sufficient additional material to overlap the outer edges of the detachable card so that the rear face of the transparent label contacts and can be attached to the surface of the advertising article 12.

The transparent label 16 can be peeled off or otherwise removed from the advertising article 12 to expose the detachable card 14. The detachable card 14 can then be removed from the advertising article 12 so that its rear face can be examined by the recipient consumer. In some embodiments, the rear face of the detachable card 14 can include a code 20 printed thereon that can be used by the consumer, once revealed by removing the detachable card from the advertising article 12. For example, the code 20 can be a discount code useful for obtaining a discount off the purchase price of goods or services. In some embodiments, the code 20 can be printed on the front face of the detachable card 14 rather than on the rear face.

By providing a covered detachable card 14, the advertiser induces or encourages consumers to spend more time or pay closer attention to examining the advertising piece and its advertising content. Consumers have an affinity for ATM, debit, credit, gift, and other payment cards. By using a detachable card 14 that is the same shape and size as such payment cards, the consumer who receives the advertising piece 10 is more likely to remove the transparent label 16 to view the rear face of the card 14, thereby increasing interaction with the advertising piece 10 with the objective of rendering the advertisement to be more effective. Either the advertising article 12 or the detachable card 14 may include printed reference to the code 20 concealed on the rear face of the detachable card.

In other embodiments, the detachable card 14 may include printed matter 18 on its front face that includes a code 18a that can be used by the recipient consumer to obtain a discount off the purchase price for goods or services. The rear face of the detachable card 14, in such embodiments, may include other printed matter or may not include printed matter.

The advertising piece 10 (i.e., the advertising article 12 and the detachable card 14 that is attached to it) may be placed inside an envelope for mailing or other distribution or delivery, or it may be mailed or distributed without using an envelope. In some embodiments, the advertising article 10 is used as a means for delivery (via the mail or otherwise) of the detachable card 14 to a recipient (e.g., an actual or a potential customer) without the necessity of using an envelope.

The invention also relates to an advertising system that includes an advertising piece as described herein above. For example, the advertising piece can include an advertising article having a first side and at least a second side, a detachable card that is removably attached to the first side of the advertising article, a transparent label that covers a front face of the detachable card and connects to the advertising article, and a code printed on the detachable card. The code is concealed when the detachable card is attached to the advertising article and is viewable upon detachment of the detachable card from the advertising article. The advertising system can also include a redemption system, which can include a software application (or “app”), or a website that is accessible via a web browser, on a computing device for checking the code to determine the amount or type of discount or prize to which the recipient may be entitled. The redemption system may further make use of a laser or optical scanner to read or recognize the code, e.g., where the code is a bar code or QR code, so that redemption system displays, announces, or otherwise conveys the amount or type of prize associated with the code. In other embodiments, the redemption system may include an input device (e.g., a keyboard, touchscreen, scanner, RFID (radio-frequency identification) device, or microphone) that is an integral part of or connected to the computing device to allow for manual or voice entry of the code, which can include alphanumeric text.

The advertising system can also include delivery systems for delivering or distributing the advertising piece to recipients. Examples of delivery systems include mail services, shipping services, vending machines (e.g., for distributing newspapers or magazines).

The invention also relates to methods for advertising that induces a consumer to view, read, or examine an advertisement. In an exemplary embodiment, the method includes the step of providing an advertising piece as described elsewhere herein. For example, the advertising piece can include an advertising article having a first side and at least a second side, a detachable card that is removably attached to the first side of the advertising article, and a transparent label that covers a front face of the detachable card and connects to the advertising article. In a next step of the method, the advertising piece is delivered to a recipient (e.g., a consumer). In a next step of the method, the recipient removes the transparent label from the advertising article to uncover the detachable card. In a next step of the method, the detachable card is removed from the advertising article to view concealed printed matter printed on the detachable card. The concealed printed matter can be printed on a rear face of the detachable card or inside the detachable card in detachable cards having folded configurations.

In another embodiment of the method, the detachable card can include a piece of material folded into a bifold or trifold configuration. In this embodiment, the method further includes the step of unfolding the detachable card after its detachment from the advertising article for viewing of the concealed printed matter.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An advertising piece comprising: an advertising article comprising a first side and at least a second side, a detachable card that is removably attached to the first side of the advertising article, and a transparent label that covers a front face of the detachable card and connects to the advertising article.

2. The advertising piece of claim 1, wherein the detachable card is attached to the first side of the advertising article within a pocket formed between a rear side of the transparent label and the first side of the advertising article.

3. The advertising piece of claim 1, wherein the advertising article, the detachable card, or both comprises printed matter.

4. The advertising piece of claim 1, wherein a rear face of the detachable card comprises concealed printed matter that is viewable when the detachable card is detached from the advertising article.

5. The advertising piece of claim 4, wherein concealed printed matter printed on the rear face of the detachable card comprises a code for obtaining a discount off a purchase price of goods or services or for obtaining a prize comprising free goods or services or money.

6. The advertising piece of claim 1, wherein the advertising article comprises a mailer or a flyer.

7. The advertising piece of claim 1, wherein the advertising article comprises a magazine, a newspaper, a brochure, a letter envelope, a folder, a package envelope, or a box.

8. The advertising piece of claim 1, wherein the detachable card comprises a length of about 85.60 mm and a height of about 53.98 mm.

9. The advertising piece of claim 1, wherein the detachable card is generally rectangular in shape and comprises rounded corners, wherein each rounded corner comprises a radius of about 2.88 mm to about 3.48 mm.

10. The advertising piece of claim 1, wherein the detachable card is shaped and sized generally the same as a debit card or credit card.

11. The advertising piece of claim 1, wherein the transparent label comprises a plastic film or a laminate that is attachable over the detachable card and onto the first side of the advertising article.

12. The advertising piece of claim 1, wherein the transparent label is clear or colored.

13. The advertising piece of claim 1, wherein the transparent label is sized to cover the detachable card with sufficient additional material to overlap outer edges of the detachable card so as to allow attachment of the transparent label to the advertising article around the outer edges of the detachable card.

14. The advertising piece of claim 1, wherein the detachable card comprises a piece of material folded into a bifold or trifold configuration that is openable after detachment of the detachable card from the advertising article.

15. The advertising piece of claim 1, further comprising adhesive that is used to attach the detachable card to the first side of the advertising article, and wherein the adhesive is present on the rear face of the transparent label, on the first side of the advertising article but not on the transparent label, or on both the rear face of the transparent label and the first side of the advertising article.

16. An advertising system comprising:
an advertising article comprising a first side and at least a second side;
a detachable card that is removably attached to the first side of the advertising article;
a transparent label that covers a front face of the detachable card and connects to the advertising article; and
a code printed on the detachable card, wherein the code is concealed when the detachable card is attached to the advertising article and is viewable upon detachment of the detachable card from the advertising article.

17. The advertising system of claim 16, wherein the code is printed on a rear face of the detachable card or inside the detachable card.

18. A method for advertising that induces a consumer to view, read, or examine an advertisement, the method comprising the steps of:
(a) providing an advertising piece comprising: an advertising article comprising a first side and at least a second side, a detachable card that is removably attached to the first side of the advertising article, and a transparent label that covers a front face of the detachable card and connects to the advertising article;
(b) delivering the advertising piece to a consumer;
(c) removing the transparent label from the advertising article to uncover the detachable card; and
(d) detaching the detachable card from the advertising article to view concealed printed matter printed on the detachable card.

19. The method of claim 18, wherein the concealed printed matter is printed on a rear face of the detachable card or inside the detachable card.

20. The method of claim 18, wherein the detachable card comprises a piece of material folded into a bifold or trifold configuration; and wherein the method further comprises the step of:
(e) unfolding the detachable card after its detachment from the advertising article for viewing of the concealed printed matter.
